(19) United States
(12) Patent Application Publication
(10) Pub. No.: US 2017/0306090 A1
(43) Pub. Date: Oct. 26, 2017

(54) METHOD FOR MAKING POLYCARBONATE USING A LIQUID KETONE MIXTURE

(71) Applicant: SABIC Global Technologies B.V., Bergen op Zoom (NL)

(72) Inventor: Ignacio Vic FERNANDEZ, Murcia (ES)

(21) Appl. No.: 15/518,267

(22) PCT Filed: Oct. 30, 2015
(86) PCT No.: PCT/IB2015/058410

§ 371 Date: Apr. 11, 2017

(30) Foreign Application Priority Data
Nov. 5, 2014 (EP) 14382438.1

(51) Int. Cl. C08G 64/30; B01J 8/02

(52) U.S. Cl. CPC C08G 64/305; C08G 64/307; B01J 8/02

(57) ABSTRACT

In an embodiment, an integrated method for producing a polycarbonate comprises: making a liquid mixture comprising a ketone and a monomer, wherein the monomer comprises a diaryl carbonate or a dihydroxy compound; transporting the liquid mixture to a polycarbonate production plant; reacting the monomer and a second monomer in a polymerization unit to produce the polycarbonate and a phenol byproduct, wherein the second monomer comprises the other of the diaryl carbonate and the dihydroxy compound; wherein the ketone comprises a non-acetone ketone. In another embodiment: a use of a liquid mixture in the production of polycarbonate, wherein the liquid mixture comprising a ketone and at least one of diaryl carbonate and dihydroxy compound, and wherein the liquid mixture comprises less than or equal to 100 ppm alcohol based on the total weight of the ketone, wherein the ketone comprises a non-acetone ketone.

### BACKGROUND

Polycarbonate (PC) is a widely used raw material in many different manufacturing sectors. Due to the hardness and transparency of the material, it can be applied in applications as diverse as automotive windows and optical lenses. It is believed that the demand for polycarbonate will increase significantly in the coming years, requiring improvement in the production of polycarbonate, particularly in terms of efficiency and environmental impact.

Polycarbonate can be polymerized via the reaction of a dihydroxy compound, such as a bisphenol, and a carbonate source, such as a diaryl carbonate. For the industrial production of polycarbonate, where the monomers are not produced on site, large amounts of these monomers need to be transported to the production facility. Significant drawbacks arise from the transport of monomers to production facilities. For example, the transport of diaryl carbonate in the solid state requires the diphenyl carbonate to be solidified after its production. This solidification is usually accomplished by cooling the diaryl carbonate, and forming it into particles, which can then be bagged and transported. These added cooling and particle formation steps can require extra equipment such as cooling bands and/or prill towers that results in an increase in capital investment and operation costs.

Furthermore, the handling and transport of solid diphenyl carbonate is prone to problems with flowability of the solid particles resulting in blockages, sintering of the particles upon exposure to even moderately elevated temperature and/or pressure, build-up of electrostatic charges upon handling, and re-melting of the solid particles for use in the polymerization reaction that not only consumes more energy, but also can lead to partial degradation and discoloration of the material due to the formation of hot spots. Additionally, contamination with dust during cooling, crushing, or transport is difficult to avoid, which can lead to contamination of the polycarbonate. Such contamination can result in a reduction in the optical properties of a polycarbonate derived therefrom.

A number of problems also arise during the transport of molten diaryl carbonate that affect both the safety and economics of the overall process due to the fact that diaryl carbonates are generally solid at ambient temperature, for example, at 23 degrees Celsius (°C.). For example, diphenyl carbonate has a melting point of 78 to 79° C. In order to help to ensure safe transport and handling of molten diphenyl carbonate (for example, with minimal waste from tank washings), a minimum temperature of 15 to 20° C. above the melting temperature of the diphenyl carbonate would have to be maintained. Maintaining such a temperature is difficult as most standard transport vessels for liquid materials are not equipped to maintain a temperature above 70° C. While some transport vessels are available that can maintain such high temperatures, such vessels are impractical due to the large amount of energy required to maintain the temperature and a tank size that is too small to support an industrial polycarbonate plant.

An improved method for monomer transport of diaryl carbonate and integration into industrial polycarbonate production facilities is needed.

### BRIEF DESCRIPTION

Disclosed herein is a method for the production of polycarbonate.

In an embodiment, an integrated method for producing a polycarbonate comprises: making a liquid mixture comprising a ketone and a monomer, wherein the monomer comprises a diaryl carbonate or a dihydroxy compound; transporting the liquid mixture to a polycarbonate production plant; reacting the monomer and a second monomer in a polymerization unit to produce the polycarbonate and a phenol byproduct, wherein the second monomer comprises the other of the diaryl carbonate and the dihydroxy compound; wherein the ketone comprises a non-acetone ketone.

In another embodiment: a use of a liquid mixture in the production of polycarbonate, wherein the liquid mixture comprising a ketone and at least one of diaryl carbonate and dihydroxy compound, and wherein the liquid mixture comprises less than or equal to 100 parts per million by weight (ppm) alcohol based on the total weight of the ketone, wherein the ketone comprises a non-acetone ketone.

The above described and other features are exemplified by the following figure and detailed description.

### BRIEF DESCRIPTION OF THE DRAWINGS

Refer now to the figure, which is an exemplary embodiment.

FIG. 1 illustrates an embodiment of a melt polymerization process.

### DETAILED DESCRIPTION

A polycarbonate production facility can consume as much as 110,000 tons per year (t/yr) of a monomer such as diaryl carbonate and bisphenol A. As is detailed above, there are many problems associated with the transport of solid and molten monomers. The Applicants therefore developed a method by which they could transport a liquid monomer mixture (also referred to as a liquid mixture) at reduced temperatures, for example, less than or equal to 70° C. for use in an industrial polymerization by preparing a liquid mixture of the monomer and a non-acetone ketone. The liquid mixture can remain in the liquid phase at a temperature of less than or equal to 70° C., specifically, 15 to 70° C., more specifically, 15 to 50° C., even more specifically, 23 to 40° C. and can therefore be successfully transported to an industrial polymerization facility. The liquid mixture can remain in the liquid phase at a temperature of 20 to 70° C., specifically, 25 to 50° C. Using this approach, the problems associated with the transporting solid monomer and molten monomer are avoided.

At the polymerization facility, the ketone and the monomer can be separated and the ketone can be used in the production of a dihydroxy compound, for example, a dihydroxy compound used in the polycarbonate polymerization.

It was further discovered that when the liquid mixture that comprises at least one of an alcohol(s) and an aldehyde(s) is directly used in a polycarbonate polymerization, the subsequent production of a dihydroxy compound using a recovered ketone resulted in a higher occurrence of side reactions. In other words, it was discovered that when a liquid mixture that comprises one or more of: an alcohol (such as methanol, ethanol, propanol, butanol, and the like) and an aldehyde (such as methanol, ethanol, propanol, butanol, and the like) is directly used in a polycarbonate polymerization, for example, that any subsequent production of a dihydroxy compound using the recovered ketone was worsened due to the higher occurrence of side reactions. For example, aldehydes can react in the dihydroxy compound reaction to form various bisphenol analogs and by-products that disadvantageously reduce product purity and have a negative impact on the color of the dihydroxy compound and final color quality of the polycarbonate through the formation of species that can easily be oxidized. Regarding the alcohol, the alcohol can react, for example, with a mercapto copromoter system that is often used in the production of a dihydroxy compound as part of the catalyst system. The mercapto copromoter system can be present in bulk (as an additive) or can be ionically bound to the base resin catalyst material.

It was discovered that the problems arising during the subsequent production of a dihydroxy compound could be reduced by reducing the total amount of alcohol, specifically, methanol, to less than 100 ppm, specifically, less than or equal to 10 ppm, more specifically, less than or equal to 1 ppm based on the total weight of the ketone; reducing the total amount of aldehydes to less than or equal to 100 ppm, specifically, to less than or equal to 10 ppm, more specifically, to less than or equal to 1 ppm based on the total weight of the ketone; or a combination comprising one or both of the foregoing. The step of reducing one or more of the alcohol and/or the aldehyde can occur prior to formation of the liquid mixture; and/or prior to addition of the liquid mixture to the polycarbonate polymerization; and/or after removal of the recovered ketone from the melt polymerization and prior to reacting the recovered ketone to form a dihydroxy compound.

Prior to forming the liquid mixture, the alcohol level in the ketone can be reduced. The alcohol reduction reaction can be performed by reacting with an alcohol, such as methanol, ethanol, and the like, present in the ketone with an amount of a diaryl carbonate such as a diaryl carbonate of the formula (I) below, for example, diphenyl carbonate, bismethyl salicylic carbonate, an activated diaryl carbonate, and the like to yield an aryl alkyl carbonate and a hydroxy compound. For example, methanol present in the ketone can react with diphenyl carbonate to form phenyl methyl carbonate and phenol. This reaction can be performed in the presence of a transesterification catalyst. As the reaction products, for example, phenyl methyl carbonate and phenol are less volatile than methanol, they are more easily separated from the ketone, for example, by distillation or flash separation.

The alcohol reduction reaction can be performed at a molar ratio of diaryl carbonate to alcohol of greater than or equal to 1, specifically, greater than or equal to 2, more specifically, greater than or equal to 5, more specifically, greater than or equal to 10. The alcohol reduction reaction can be performed at a temperature of greater than or equal to 50° C., specifically, greater than or equal to 100° C., more specifically, greater than or equal to 130° C., even more specifically, greater than or equal to 145° C.

The transesterification catalyst can comprise an acidic catalyst, for example, with or without a mercapto copromoter system. The transesterification catalyst can comprise a basic catalyst, for example, a quaternary ammonium compound, a quaternary phosphonium compound, or a combination comprising at least one of the foregoing. The transesterification catalyst can comprise tetramethyl ammonium hydroxide (TMAOH). Transesterification catalysts are described in more detail below. The alcohol reduction reaction can be performed at a molar ratio of transesterification catalyst to alcohol of greater than or equal to 1, specifically, greater than or equal to 2, more specifically, greater than or equal to 5, even more specifically, greater than or equal to 10.

The Applicants further discovered that the problems arising during the subsequent production of a dihydroxy compound could be reduced by reducing the metal content. The metal can arise from, for example, a metal catalyst used to catalyze a reaction, metal ions from reactor and/or conduit materials (e.g., steel (such as iron, chromium, nickel, and molybdenum)), metal ions present in water used in a reaction (such as sodium, calcium, and magnesium), or a combination comprising one or more of the foregoing. A reduced metal content can result in a polycarbonate with a low color value of, for example, a CIE b* index of less than or equal to 0.5, specifically, less than or equal to 0.15 as determined by spectrophotometry and high light transmission of, for example, greater than or equal to 89% as determined by spectrophotometry. The polycarbonate can have a light transparency of greater than 90% as determined using 3.2 mm thick samples using ASTM D1003-00, Procedure B using CIE standard illuminate C, with unidirectional viewing. When the polycarbonate has such a light transparency, it is herein referred to as an “optical grade” PC.

The mixture can comprise the ketone and a monomer. The monomer can comprise a dihydroxy compound of the formula HO—R¹—OH, in which the R¹ groups contain aliphatic, alicyclic, and/or aromatic moieties. The dihydroxy monomer can comprise a dihydroxy monomer of formula (2): HO-A^{l}-Y^{l}-A²-OH (2), wherein each of A^{l} and A² is a monocyclic divalent aromatic group and Y¹ is a single bond or a bridging group having one or more atoms that separate A^{l} from A².

The monomer can comprise a diaryl carbonate of the formula (I)

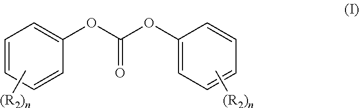

wherein n is an integer of 1 to 3 and each R₂ is independently linear or branched; optionally substituted; C₁₋₃₄ alkyl, specifically, C₁₋₆ alkyl, more specifically, C₁₋₄ alkyl; C₁₋₃₄ alkoxy, specifically, C₁₋₆ alkoxy, more specifically, C₁₋₆ alkoxy; C₅₋₃₄ cycloalkyl; C₇₋₃₄ alkylaryl; C₆₋₃₄ aryl; or a halogen radical, specifically, a chlorine radical. R₂ can also represent —COO—R′, wherein R′ can be H; C₁₋₃₄ alkyl, specifically, C₁₋₆ alkyl, more specifically, C₁₋₄ alkyl; C₁₋₃₄ alkoxy, specifically, C₁₋₁₆ alkoxy, specifically, C₁₋₄ alkoxy; C₅₋₃₄ cycloalkyl; C₇₋₃₄ alkylaryl; or C₆₋₃₄ aryl. The diaryl carbonate can comprise diphenyl carbonate.

The mixture can comprise the ketone and the monomer, for example, a diaryl ketone in a molar ratio of greater than or equal to 0.5:1, specifically, greater than or equal to 0.6:1, more specifically, greater than or equal to 0.8:1, even more specifically, greater than or equal to 0.9:1. The mixture can comprise the ketone and the monomer in a molar ratio of less than or equal to 5:1, specifically, less than or equal to 3.5:1, more specifically, less than or equal to 3, even more specifically, less than or equal to 2.5, still more specifically, less than or equal to 2:1. The mixture can comprise the ketone and the monomer in a molar ratio of 0.5:1 to 7:1, specifically, 0.5:1 to 5:1, more specifically, 0.5:1 to 3:1, even more specifically, 1:1 to 3:1. The mixture can comprise 10 to 90 weight percent (wt %), specifically, 20 to 80 wt %, more specifically, 25 to 65 wt % of the ketone based on the total weight of the mixture.

The mixture can further comprise an aryl alcohol. The mixture can comprise 0 to 10 wt % of aryl alcohol, specifically, 1 to 8 wt % of aryl alcohol, more specifically, 1.5 to 5 wt % aryl alcohol based on the total weight of the mixture. Accordingly, any residual aryl alcohol, for example, in the production of the diaryl carbonate can be present in the mixture.

The mixture can be made by combining the monomer and the ketone at the monomer production site, for example, by adding the ketone to a stirred vessel containing the liquid monomer, or by adding the liquid monomer to the ketone, until the desired ketone/monomer ratio is obtained. The liquid monomer can be the direct product mixture from the monomer reaction. Conversely, an alcohol and/or a metal contaminant level in the monomer product mixture can be reduced prior to mixing with the ketone.

In order to avoid hydrolysis of the diaryl carbonate, the mixture can be free of water. For example, the mixture can comprise less than or equal to 1 wt % water, specifically 0 to 0.3 wt %, more specifically, 0 to 0.2 wt % based on the total weight of the mixture.

The diaryl carbonate of the general formula (I) can comprise diphenyl carbonate, methylphenyl-phenyl carbonates and di-(methylphenyl) carbonates (wherein the methyl group can be in any desired position on the phenyl rings), dimethylphenyl-phenyl carbonates and di-(dimethylphenyl) carbonates (wherein the methyl groups can be in any desired position on the phenyl rings, for example, 2,4-, 2,6-, 3,5-or 3,4-dimethylphenyl), chlorophenyl-phenyl carbonates and di-(chlorophenyl) carbonates (wherein the chloro atom can be in any desired position on the phenyl rings, for example, 2-, 3-, or 4-chlorophenyl), 4-ethylphenyl-phenyl carbonate, di-(4-ethylphenyl) carbonate, 4-n-propylphenyl-phenyl carbonate, di-(4-n-propylphenyl) carbonate, 4-isopropylphenyl-phenyl carbonate, di-(4-isopropylphenyl) carbonate, 4-n-butylphenyl-phenyl carbonate, di-(4-n-butylphenyl) carbonate, 4-isobutylphenyl-phenyl carbonate, di-(4-isobutylphenyl) carbonate, 4-tert-butylphenyl-phenyl carbonate, di-(4-tert-butylphenyl) carbonate, 4-n-pentylphenyl-phenyl carbonate, di-(4-n-pentylphenyl) carbonate, 4-n-hexylphenyl-phenyl carbonate, di-(4-n-hexylphenyl) carbonate, 4-isooctylphenyl-phenyl carbonate, di-(4-isooctylphenyl) carbonate, 4-n-nonylphenyl-phenyl carbonate, di-(4-n-nonyl-phenyl) carbonate, 4-cyclohexylphenyl-phenyl carbonate, di-(4-cyclohexylphenyl) carbonate, 4-(1 -methyl-l-phenylethyl)-phenyl-phenyl carbonate, di-[4-(1-methyl-1-phenylethyl)-phenyl]carbonate, biphenyl-4-yl-phenyl carbonate, di-(biphenyl-4-yl) carbonate, (1-naphthyl)-phenyl carbonate, (2-naphthyl)-phenyl carbonate, di-(1-naphthyl) carbonate, di-(2-naphthyl) carbonate, 4-(1-naphthyl)-phenyl-phenyl carbonate, 4-(2-naphthyl)-phenyl-phenyl carbonate, di-[4-(1-naphthyl)-phenyl]carbonate, di-[4-(2 -naphthyl)phenyl]carbonate, 4-phenoxyphenyl-phenyl carbonate, di-(4-phenoxyphenyl) carbonate, 3-pentadecylphenyl-phenyl carbonate, di-(3-pentadecylphenyl) carbonate, 4-tritylphenyl-phenyl carbonate, di-(4-tritylphenyl) carbonate, methyl salicylate-phenyl carbonate, di-(methyl salicylate) carbonate, ethyl salicylate-phenyl carbonate, di-(ethyl salicylate) carbonate, n-propyl salicylate-phenyl carbonate, di-(n-propyl salicylate) carbonate, isopropyl salicylate-phenyl carbonate, di-(isopropyl salicylate) carbonate, n-butyl salicylate-phenyl carbonate, di-(n-butyl salicylate) carbonate, isobutyl salicylate-phenyl carbonate, di-(isobutyl salicylate) carbonate, tert-butyl salicylate-phenyl carbonate, di-(tert-butyl salicylate) carbonate, di-(phenyl salicylate)-carbonate, di-(benzyl salicylate) carbonate, and combinations comprising one or more of the foregoing. The diaryl carbonate can comprise diphenyl carbonate.

There are several methods by which diaryl carbonate can be produced. One method for producing diaryl carbonate includes decarbonylating a diaryl oxalate (such as diphenyl oxalate) in the presence of a decarbonylation catalyst while removing a carbon monoxide by product. The decarbonylation reaction can occur in the liquid phase. The diaryl oxalate can comprise a diaryl oxalate of the formula: ArO(C═O)—(C═O)OAr, where each Ar independently can be an aromatic hydrocarbon group having 6 to 14 carbon atoms, for example, Ar can be a phenyl group, which can be substituted with at least one selected from alkyl groups having 1 to 6 carbon atoms (such as methyl, ethyl, propyl, butyl, pentyl, and hexyl), alkoxy groups having 1 to 6 carbon atoms (such as methoxy, propoxy, butoxy, pentoxy, and hexoxy), and halogen atoms (such as fluorine, chlorine, bromine, and iodine). The diaryl oxalate can comprise diphenyl oxalate, m-cresyl oxalate, m-cresyl phenyl oxalate, p-cresyl oxalate, p-cresyl phenyl oxalate, dinaphthyl oxalate, bis(diphenyl)oxalate, bis(chlorophenyl)oxalate, or a combination comprising one or more of the forgoing. The diaryl oxalate can contain less than or equal to 5 ppm, specifically, less than or equal to 2 ppm of a hydrolyzable halogen.

The diaryl oxalate can be prepared by transesterifying a dialkyl oxalate (such as dimethyl oxalate) with a hydroxyaryl compound (such as phenol) in the presence of a transesterification catalyst, where the transesterification reaction can occur in the liquid phase. The dialkyl oxalate can comprise one or more lower dialkyl oxalates of which the alkyl group comprises 1 to 6 carbon atoms, for example, dimethyl oxalate, diethyl oxalate, dipropyl oxalate, dibutyl oxalate, dipentyl oxalate, and dihexyl oxalate.

The transesterification catalyst used for the preparation of the diaryl oxalate from the dialkyl oxalate and the hydroxyaryl compound can comprise at least one of, for example, compounds and complexes of alkali metals, compounds and complexes of cadmium and zirconium, lead-containing compounds, iron-containing compounds, copper group metal compounds, silver-containing compounds, zinc-containing compounds, organic tin compounds, and Lewis acid compounds of aluminum, titanium, and vanadium. The decarbonylation catalyst can comprise at least one organic phosphorus compound (such as an organic phosphine compound, an organic phosphine oxide compound, an organic phosphine dihalide compound, and an organic phosphonium salt compound). The decarbonylation catalyst can contain a halogen, for example, on the phosphorus containing compound or as a separate halogen compound. Another method for producing diaryl carbonate includes reacting an aromatic hydroxy compound and carbon monoxide in the presence of oxygen, where the reaction can be facilitated by a catalyst and an optional organic salt. For example, the reaction can be the oxidative carbonylation of phenol, where the reaction can occur in a fixed-bed reactor or in an autoclave reactor. Suitable catalysts for the oxidative carbonylation of aromatic hydroxy compounds include a palladium catalyst. The palladium catalyst can be in solvated form (such as PdBr₂ promoted with transition metal oxides and solvated promoters, including one or more of N(Bu)₄Br, Mn(AcAc)₂, NaO(C₆H₅) and the like), suspended form with Pd supported on pulverized TiO₂, or extrudate form with Pd supported on rare earth metal oxide. The palladium catalyst can comprise Pd(OAc)₂/hydrotalcite. As used herein, Bu means butyl, AcAc means acetylacetonate, and OAc means acetate. The catalyst can comprise a cocatalyst, such as a cesium compound, a manganese compound, a cobalt compound, a copper compound, hydroquinone, benzoquinone, naphthoquinone, or a combination comprising one or more of the foregoing. The organic salt can comprise, for example, ⁿBu₄NBr, ⁿBu₄PBr, PPNBr, and the like.

The aromatic hydroxy compound can comprise an aromatic hydroxy compound of the formula (III), wherein n and R₂ are defined as above in formula (I).

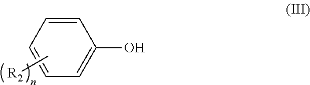

The aromatic hydroxy compound can comprise phenol, o-, m- or p-cresol, dimethylphenol (wherein the methyl groups can be in any desired position on the phenol ring, for example, 2,4-, 2,6-or 3,4-dimethylphenol), o-, m- or p-chlorophenol, o-, m- or p-ethylphenol, o-, m- or p-n-propylphenol), 4-isopropylphenol, 4-n-butylphenol, 4-isobutyl phenol, 4-tert-butylphenol, 4-n-pentylphenol, 4-n-hexylphenol, 4-isooctylphenol, 4-n-nonylphenol, o-, m- or p-methoxyphenol, 4-cyclohexylphenol, 4-(1-methyl-l-phenylethyl)-phenol, biphenyl-4-ol, 1-naphthol, 2-naphthol, 4-(1-naphthyl)phenol, 4-(2-naphthyl)phenol, 4-phenoxyphenol, 3-pentadecylphenol, 4-tritylphenol, salicylic acid methyl ester, salicylic acid ethyl ester, salicylic acid n-propyl ester, salicylic acid isopropyl ester, salicylic acid n-butyl ester, salicylic acid isobutyl ester, salicylic acid tert-butyl ester, salicylic acid phenyl ester, salicylic acid benzyl ester, or a combination comprising one or more of the foregoing.

The aromatic hydroxy compound can comprise phenol, 4-tert-butylphenol, biphenyl-4-ol, 4-(1-methyl-1-phenylethyl)-phenol, or a combination comprising one or more of the foregoing.

Other methods for producing diaryl carbonate can be found in U.S. Pat. Nos. 5,922,827, 6,265,524, 5,831,111, and 5,710,310 and include reacting an aromatic hydroxy compound, which can comprise the aromatic hydroxy compound of formula III, with phosgene in either the gas or liquid phase, for example, the direct phosgenation of phenol and reacting an aromatic hydroxy compound with a dialkyl carbonate, where said reactions can occur in the presence of a transesterification catalyst. The aromatic hydroxy compound and either phosgene or the dialkyl carbonate can be added in a molar ratio of 1:0.1 to 1:10, specifically, 1:0.2 to 1:5, more specifically, 1:0.5 to 1:3. The indicated molar ratio does not take into account any recycled components that can be added back to the production column.

The dialkyl carbonate can comprise the dialkyl carbonate of the formula (II)

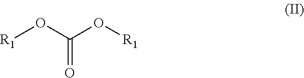

wherein each R₁ independently is linear or branched; optionally substituted; C₁₋₃₄ alkyl, specifically, C₁₋₆ alkyl, more specifically, C₁₋₄ alkyl. The C₁₋₄ alkyl can comprise methyl, ethyl, n-propyl, isopropyl, n-butyl, sec-butyl, tert-butyl, or a combination comprising one or more of the foregoing. The C₁₋₆ alkyl can comprise n-pentyl, 1-methylbutyl, 2-methylbutyl, 3-methylbutyl, neopentyl, 1-ethylpropyl, cyclohexyl, cyclopentyl, n-hexyl, 1,1-dimethyl propyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethyl butyl, 3,3-dimethylbutyl, 1-ethylbutyl, 2-ethylbutyl, 1,1,2-trimethylpropyl, 1,2,2-trimethyl propyl, 1-ethyl-l-methylpropyl, 1-ethyl-2-methylpropyl, or a combination comprising one or more of the foregoing. The C₁-C₃₄-alkyl can comprise n-heptyl, n-octyl, pinacyl, adamantyl, an isomeric menthyl, n-nonyl, n-decyl, n-dodecyl, n-tridecyl, n-tetradecyl, n-hexadecyl, or n-octadecyl, or a combination comprising one or more of the foregoing.

The dialkyl carbonates can comprise dimethyl carbonate, diethyl carbonate, dipropyl carbonate (e.g., di(n-propyl) carbonate, and/or di(isopropyl) carbonate), dibutyl carbonate (e.g., di(n-butyl) carbonate, di(sec-butyl) carbonate, and/or di(tert-butyl) carbonate), dihexyl carbonate, or a combination comprising one or more of the foregoing.

A catalyst can be used to facilitate the reaction between the aromatic hydroxy compound and either phosgene or the dialkyl carbonate. The catalyst can be a homogeneous catalyst and/or a heterogeneous catalyst, wherein a heterogeneous catalyst comprises two or more catalysts. The catalyst can comprise hydrides, oxides, hydroxides, alcoholates, amides and other salts of alkali and alkaline earth metals, such as of lithium, sodium, potassium, rubidium, cesium, magnesium and calcium, specifically, lithium, sodium, potassium, magnesium, calcium, or a combination comprising one or more of the foregoing. Some examples of catalyst are set forth in U.S. Pat. No. 5,831,111.

The catalyst, when homogeneous, can be introduced to the reaction mixture in dissolved or suspended form together with the stream containing the aromatic hydroxy compound. Alternatively, the catalyst can be introduced, for example, in the reaction alcohol or a suitable inert solvent. A heterogeneous catalyst can be used in a packed bed, a column, or in special catalytic distillation arrangements, as well as in other arrangements.

A metal contaminant in the diaryl carbonate (DAC) can be reduced. The metal contaminant can comprise titanium, lead, tin, zirconium, molybdenum, niobium, vanadium, iron, zinc, aluminum, yttrium, lanthanum, hafnium, tungsten, neodymium, samarium, copper, ytterbium, chromium, nickel, manganese, bismuth, niobium, or a combination comprising one or more of the foregoing.

The DAC can comprise less than or equal to 38 parts per billion by weight (ppb), specifically, less than or equal to 23 ppb of molybdenum; less than or equal to 38 ppb, specifically, less than or equal to 23 ppb vanadium; less than or equal to 38 ppb, specifically, less than or equal to 23 ppb chromium; less than or equal to 85 ppb, specifically, less than or equal to 57 ppb titanium; less than or equal to 425 ppb, specifically, less than or equal to 284 ppb of niobium; less than or equal to 38 ppb, specifically, less than or equal to 23 ppb of nickel; less than or equal to 12 ppb, specifically, less than or equal to 6 ppb zirconium; less than or equal to 12 ppb, specifically, less than or equal to 6 ppb of iron, or a combination comprising one or more of the foregoing all based on the total weight of the diaryl carbonate.

The metal contaminant in the diaryl carbonate can be reduced by introducing an aqueous stream to a diaryl carbonate stream that comprises a metal contaminant such that the metal contaminant can be precipitated to its oxide and/or hydroxide form. It is noted that this metal contaminant reduction method could likewise be performed on a dihydroxy compound containing a metal contaminant. The aqueous stream can be introduced such that greater than or equal to 100 ppm, specifically, 100 to 10,000 ppm, more specifically, 200 to 8,000 ppm, yet more specifically, 500 to 7,000 ppm, e.g., 1,000 to 7,000 ppm, of water is introduced based on the total weight of the diaryl carbonate stream and the aqueous stream. The aqueous stream can comprise sodium bicarbonate (or other salts of the alkali and alkaline earth metals such as carbonates or hydrogen carbonates, phosphates, hydrogen phosphates, borates, acetates, propionates) in addition to water.

The introduction of the aqueous stream can occur at a temperature of greater than or equal to the melting point of the diaryl carbonate in order to ensure that the diaryl carbonate is a molten diaryl carbonate. Further increasing the temperature to a temperature greater than the melting point of the diaryl carbonate, for example, to a temperature of greater than 100° C., can reduce the viscosity of the molten diaryl carbonate. The introduction of the aqueous stream can occur at a temperature of greater than or equal to 80° C., specifically, greater than or equal to 90° C., more specifically, greater than 100° C., even more specifically, 110 to 250° C., still more specifically, 120 to 250° C.

The introduction of the aqueous stream can occur in the presence of 0 to 50 wt %, specifically, 0 to 25 wt %, more specifically, 0 to 1 wt %, even more specifically, 0 wt% of a solvent based on the total weight of the diaryl carbonate stream and the aqueous stream. For example, the diaryl carbonate stream can be free of any added solvent (e.g., no solvent is added to the diaryl carbonate stream prior to the introduction of the aqueous stream). Examples of solvents include aliphatic hydrocarbons (such as pentane, petroleum ether, cyclohexane, and isooctane), aromatic hydrocarbons (such as benzene, toluene, and xylene), chloroaromatic compounds (such as chlorobenzene and dichlorobenzene), ethers (such as dioxane, tetrahydrofuran, tert-butyl methyl ether, and anisole), amides (such as dimethylacetamide and N-methyl-pyrrolidinone), and alcohols (such as tert-butanol, cumyl alcohol, isoamyl alcohol, diethylene glycol, and tetramethylurea).

The introduction of the aqueous stream can be facilitated by the use of a mixing device, where the mixing device can refer to any type of apparatus that is capable of facilitating the necessary contact between the diaryl carbonate stream and water in order to achieve the hydrolysis reaction of the metal contaminant The mixing device can comprise any type of stirring device and/or static mixer with appropriate mixing elements, and/or a tube with turbulent flow that facilitates the mixing. The mixing device can be a continuously stirred-tank reactor (CSTR).

Once the metal contaminant is precipitated, it can then be easily separated by a separation process utilizing one or both of a separation column and a filter to result in a purified diaryl carbonate. When both a separation column and a filter are used, the filter can be upstream of the separation column and/or downstream of the separation column. If multiple separation columns are present, a filter can be present upstream and/or downstream of one or more of the separation columns.

When the separation process utilizes a separation column, the separation column can be a distillation column, a reactive distillation column, a catalytic distillation column, or the like. The column can contain concentrating part(s) in the upper portion of the separation column and zone(s) beneath the concentrating part, which can have at least two sections, wherein concentrating part(s) of the separation column can be equipped with intermediate condenser(s). Each of the sections, independently of the others, can have 5 or greater, specifically, 10 or greater theoretical equilibrium stages. At the top of the separation column, the reflux stream can be condensed in a condenser, wherein at least a portion of the condensed vapor can re-enter the separation column. At the bottom of the separation column, the bottom stream can be heated in a reboiler, wherein at least a portion of the heated bottom stream can re-enter the separation column. The aqueous stream can be introduced to the diaryl carbonate stream in a mixing device that is located upstream of the separation column and/or that is located downstream of the condenser and upstream of the separation column. When a mixing device is located downstream of the condenser and upstream of the separation column, the aqueous stream and the diaryl carbonate stream, that is the portion of the reflux stream (also referred to as a top stream first portion) to be reintroduced, are introduced to the mixing device, mixed, and introduced to the separation column. The separation column can comprise a set of cascading separation columns to obtain even higher purity DPC.

When the separation process utilizes a filter, the mesh size of the filter can be less than or equal to 20 micrometers, specifically, less than or equal to 1 micrometer, more specifically, less than or equal to 0.2 micrometers.

The residual water in the DAC can be less than or equal to 1,000 ppm, specifically, less than or equal to 500 ppm, more specifically, less than or equal to 100 ppm.

The freshly produced liquid monomer, for example, a liquid diaryl carbonate can be mixed with the ketone, thereby avoiding hot storage of the monomer. For example, a liquid diaryl carbonate can be mixed with the ketone prior to solidification of the liquid monomer, e.g., within 1 hour of liquid monomer production, or can be mixed in less than or equal to 0.5 hours of the liquid monomer production. For example, a liquid mixture can be formed by mixing the molten diaryl carbonate with the ketone under a positive pressure to reduce evaporation of the ketone, optionally followed by downstream cooling of the liquid mixture. Conversely, or in addition, solid flakes of diaryl carbonate and the ketone can be mixed, optionally with heating, to form the liquid mixture.

The ketone comprises a non-acetone ketone, such as of greater than or equal to 90 wt %, specifically, greater than or equal to 99 wt %, and more specifically, greater than or equal to 99.9 wt % non-acetone ketone, based upon the total weight of the ketone. For example, the ketone can comprise methyl isobutyl ketone (MIBK), benzophenone, cyclohexanone, acetophenone, butanone, diethyl ketone, or a combination comprising one or more of the foregoing. The ketone can comprise benzophenone, cyclohexanone, acetophenone, butanone, or a combination comprising one or more of the foregoing. The ketone can comprise benzophenone. The ketone can comprise cyclohexanone. The ketone can comprise acetophenone. The ketone can comprise butanone. If the ketone comprises acetone, it can be present in an amount of less than or equal to 25 wt %, specifically, less than or equal to 10 wt %, and more specifically, less than or equal to 5 wt %, based upon the total weight of the ketone. Optionally, no acetone is present.

$${M}_{k} \leq {M}_{B} ( \frac{{M}_{w ( ketone )}}{{M}_{w ( monomer )}} ) \qquad ( F )$$

The ketone can comprise an amount of metals based upon the following formula (F), wherein Mₖ is the amount of metal in the ketone in ppb; M_{w(ketone)} is the weight average molecular weight of the ketone; M_{w(monomer)} is the weight average molecular weight of the monomer that is mixed with the ketone; and M_{B} is the amount of metal for each different metal and comprises the following: molybdenum: less than or equal to 38 ppb, specifically, less than or equal to 23 ppb; and/or vanadium: less than or equal to 38 ppb, specifically, less than or equal to 23 ppb; and/or chromium: less than or equal to 38 ppb, specifically, less than or equal to 23 ppb; and/or titanium: less than or equal to 85 ppb, specifically, less than or equal to 57 ppb; and/or niobium: less than or equal to 425 ppb, specifically, less than or equal to 284 ppb; and/or nickel: less than or equal to 38 ppb, specifically, less than or equal to 23 ppb; and/or zirconium: less than or equal to 12 ppb, specifically, less than or equal to 6 ppb; and/or iron: less than or equal to 12 ppb, specifically, less than or equal to 6 ppb.

The liquid mixture can then be transported to a polycarbonate production plant. Storage and transport vessels include vessels such as road and rail tankers, bulk containers, tank barges and tank ships, storage tanks, drums and pipelines. The containment material for the mixture of the storage and transport vessels can comprise stainless steel.

The mixture can be maintained at a transport temperature of 20 to 70° C., specifically, 20 to 50° C. The transport temperature can be maintained at plus or minus 10° C., specifically, plus or minus 5° C. of a set transport temperature. If the mixture is transported at a temperature greater than the ambient temperature, the transport and storage vessels can be insulated to reduce heat loss, and equipped with the necessary safety devices required.

During storage and transport, additional ketone can be added to the mixture or an amount of ketone can be removed, e.g., to adjust a monomer to ketone molar ratio.

Upon arrival at the polycarbonate production facility, the mixture can optionally be separated into the separated monomer and the separated ketone prior to introduction of the monomer into the polymerization unit, or the mixture can be added to the polymerization unit without prior separation. The mixture can be separated by, for example, distillation (such as flash distillation, continuous distillation, or a combination comprising one or both of the foregoing), evaporation (such as in a continuous film evaporator), or a combination comprising one or both of the foregoing. If the ketone is separated from the diaryl carbonate, the diaryl carbonate can comprise less than or equal to 3 wt %, specifically, less than or equal to 2 wt %, more specifically, less than or equal to 1 wt %, and still more specifically, 0.1 to 1 wt %, of the ketone based on the total weight of the separated monomer.

Optionally, the mixture can be introduced to the polymerization unit comprising greater than or equal to 5 wt %, specifically, greater than or equal to 10 wt %, more specifically, greater than or equal to 20 wt % of ketone. Ketone can later be recovered from the polymerization unit (referred to herein as a recovered ketone), e.g., along with any recovered phenol by-product. The recovered ketone can be recovered as a component in a recovered mixture. The recovered mixture can comprise the recovered ketone, phenol by-product, one or more monomers, oligomers, a nitrogen-containing basic compound, an alkali metal compound, an alkaline earth metal compound, boric acid, a boric acid ester, ammonium hydrogen phosphite, phenyl salicylate, o-phenoxybenzoic acid, phenyl o-phenoxybenzoate, or a combination comprising one or more of the foregoing.

One or both of the recovered ketone and the phenol by-product can be separated from the recovered mixture, for example, prior to use in the production of a dihydroxy compound. The separating can occur, for example, in one or more separation columns. The separating can comprise hydrolyzing an impurity by adding water or a water-acetone mixture to the recovered mixture and removing the hydrolyzed compounds. The hydrolyzing can occur at a temperature of 50 to 200° C. for 1 minute to 3 hours. The amount of water added can be at least equimolar to less than or equal to 10 times the total molar amount of the components in the recovered mixture.

The separated phenol byproduct can comprise less than or equal to 0.2 wt %, specifically, less than or equal to 0.1 wt % of water based on the total weight of the separated phenol by-product. A separated phenol by-product can comprise 70 to 99 wt %, specifically, 80 to 99 wt %, more specifically, 90 to 99 wt % of phenol based on the total weight of the separated phenol by-product.

The separated ketone can be a precursor in the production of a dihydroxy compound that can be used in a polycarbonate polymerization reaction. For example, a separated benzophenone can be used as a precursor in the preparation of bisphenol benzophenone (bisphenol BP); a separated cyclohexanone can be used as a precursor in the preparation of bisphenol cyclohexanone (bisphenol Z); a separated acetophenone can be used as a precursor in the preparation of bisphenol acetophenone (bisphenol AP); and a separated butanone can be used as a precursor in the preparation of bisphenol butanone (bisphenol B).

The separated ketone can be reacted with a hydroxyl compound such as phenol, for example, the phenol byproduct from a polycarbonate polymerization, in the presence of a catalyst to produce the dihydroxy compound. The dihydroxy compound production reaction can be performed at a molar ratio of the separated ketone to phenol of 1:2 to 1:20, specifically, 1:3 to 1:10. The dihydroxy compound production reaction can be performed at a temperature of 50 to 90° C. The catalyst can comprise a strong acid, for example, hydrochloric acid. The catalyst can comprise an ion exchange resin, for example, a sulfonated polystyrene resin.

The separated ketone for the production of a dihydroxy compound can comprise less than or equal to 100 ppm of an alcohol such as methanol, specifically, less than or equal to 10 ppm of alcohol based on the total weight of the separated ketone. Alcohol present in the separated ketone and/or the recovered ketone can be removed as described above prior to use in a dihydroxy compound formation reaction.

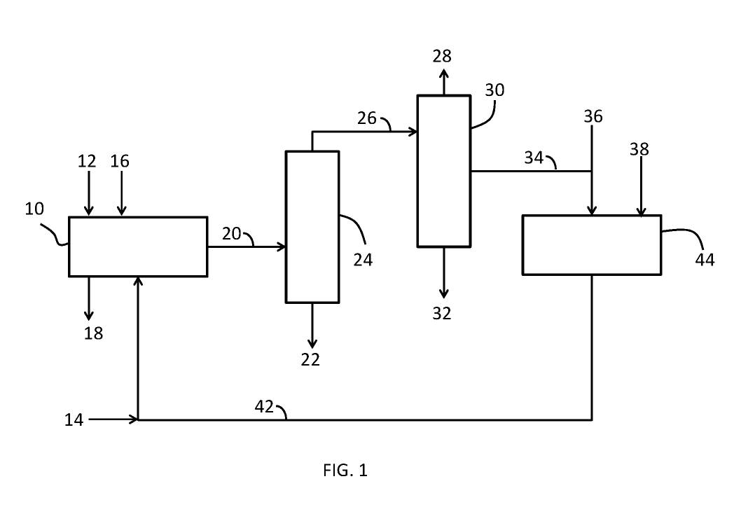

FIG. 1 illustrates a method of using a purified phenol by-product in the melt polymerization. Specifically, catalyst stream 12, first monomer stream 14, and second monomer stream 16 are added to melt polymerization system 10 to produce polycarbonate stream 18 and phenol by-product stream 20, where it is noted that melt polymerization unit 10 can comprise one or more polymerization units. One or both of first monomer stream 14 and second monomer stream 16 can comprise a ketone, where if the ketone is added to the melt polymerization system 10, then phenol by-product stream 20 will comprise the ketone. Phenol by-product stream 20 is fed into first separation unit 24, where first separated phenol stream 26 is fed to second separation unit 30. One or more of streams 22, 32, and 28 can comprise a recovered ketone. Second separated phenol stream 34 is combined with optional phenol stream 36 and is added to monomer production unit 44. Monomer production unit 44 can produce a dihydroxy compound or a diaryl carbonate. Reactant stream 38 can be added to monomer production unit 44 and can comprise a reactant. For example, in the production of a dihydroxy compound, reactant stream 38 can comprise one or both of a recovered ketone and a separated ketone. Reactant stream 38 can be purified prior to adding to monomer production unit 44. Reactant stream 38 can comprise a recovered ketone recovered in one or more of streams 22, 32, and 28. A catalyst can further be added to monomer production unit 44. Produced monomer stream 42 can be added to melt polymerization system 10. Produced monomer stream 42 can be purified prior to addition to melt polymerization system 10.

The dihydroxy compound can have a reduced metal level of less than or equal to 38 ppb, specifically, less than or equal to 23 ppb of molybdenum; less than or equal to 38 ppb, specifically, less than or equal to 23 ppb vanadium; less than or equal to 38 ppb, specifically, less than or equal to 23 ppb chromium; less than or equal to 85 ppb, specifically, less than or equal to 57 ppb titanium; less than or equal to 425 ,ppb, specifically, less than or equal to 284 ppb of niobium; less than or equal to 38 ppb, specifically, less than or equal to 23 ppb of nickel; less than or equal to 12 ppb, specifically, less than or equal to 6 ppb zirconium; less than or equal to 12 ppb, specifically, less than or equal to 6 ppb of iron, or a combination comprising one or more of the foregoing all based on the total weight of dihydroxy compound.

The separated monomer is used in the production of a polycarbonate, for example, the separated monomer can comprise a diaryl carbonate and can be used in a reaction with a dihydroxy compound derived from the separated ketone. A “polycarbonate” means compositions having repeating structural carbonate units of formula (1), in which the R^{l} groups contain aliphatic, alicyclic, and/or aromatic moieties (e.g., greater than or equal to 30%, specifically, greater than or equal to 60%, of the total number of R^{l} groups can contain aromatic moieties and the balance thereof are aliphatic, alicyclic, or aromatic). Optionally, each le can be a C₆₋₃₀ aromatic group, that is, can contain at least one aromatic moiety. R^{l} can be derived from a dihydroxy compound of the formula HO-R¹—OH, in particular of formula (2) as described above, and where one atom can separate A^{l} from A². Specifically, each le can be derived from a dihydroxy aromatic compound of formula (3), wherein R^{a} and R^{b} are each independently a halogen, C₁₋₁₂ alkoxy, or C₁₋₁₂ alkyl; and p and q are each independently integers of0 to 4. It will be understood that R^{a} is hydrogen when p is 0, and likewise R^{b} is hydrogen when q is 0. Also in formula (3), X^{a} is a bridging group connecting the two hydroxy-substituted aromatic groups, where the bridging group and the hydroxy substituent of each C₆ arylene group are disposed ortho, meta, or para (specifically, para) to each other on the C₆ arylene group. The bridging group X^{a} can be single bond, —O—, —S—,—S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. p and q can each be 1, and R^{a} and R^{b} are each a C₁₋₃ alkyl group, specifically, methyl, disposed meta to the hydroxy group on each arylene group.

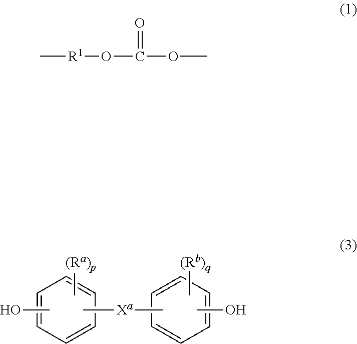

X^{a} can be a substituted or unsubstituted C₃₋₁₈ cycloalkylidene, a C₁₋₂₅ alkylidene of formula —C(R^{c})(R^{d})—wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})—wherein R^{e} is a divalent C₁₋₁₂ hydrocarbon group. Groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

X^{a} can be a C₁₋₁₈ alkylene group, a C₃₋₁₈ cycloalkylene group, a fused C₆₋₁₈ cycloalkylene group, or a group of the formula —B¹—G—B²— wherein B¹ and B² are the same or different C₁₋₆ alkylene group and G is a C₃₋₁₂ cycloalkylidene group or a C₆₋₁₆ arylene group. For example, X^{a} can be a substituted C₃₋₁₈ cycloalkylidene of formula (4), wherein R^{r}, R^{P}, R^{q}, and R^{t} are each independently hydrogen, halogen, oxygen, or C₁₋₁₂ hydrocarbon groups; Q is a direct bond, a carbon, or a divalent oxygen, sulfur, or —N(Z)—where Z is hydrogen, halogen, hydroxy, C₁₋₁₂ alkyl, C₁₋₁₂ alkoxy, or C₁₋₁₂ acyl; r is 0 to 2, t is 1 or 2, q is 0 or 1, and k is 0 to 3, with the proviso that at least two of R^{r}, R^{P}, R^{q}, and R^{t} taken together are a fused cycloaliphatic, aromatic, or heteroaromatic ring. Where the fused ring is aromatic, the ring as shown in formula (4) will have an unsaturated carbon-carbon linkage where the ring is fused. When k is one and i is 0, the ring as shown in formula (4) contains 4 carbon atoms, when k is 2, the ring as shown in formula (4) contains 5 carbon atoms, and when k is 3, the ring contains 6 carbon atoms. Two adjacent groups (e.g., R^{q} and R^{t} taken together) can form an aromatic group or R^{q} and R^{t} taken together can form one aromatic group and R^{r}and R^{P} taken together form a second aromatic group. When R^{q} and R^{t} taken together form an aromatic group, R^{P} can be a double-bonded oxygen atom, i.e., a ketone.

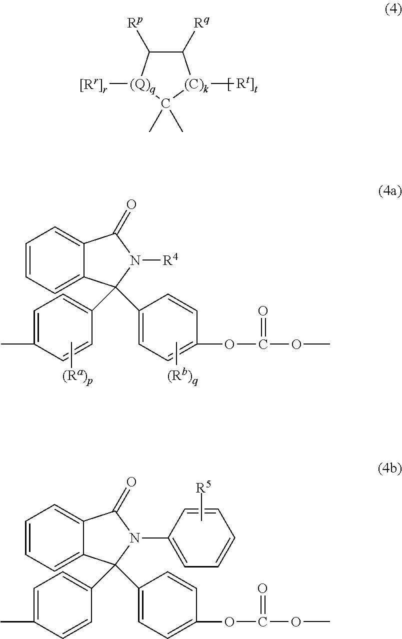

Bisphenols (4) can be used in the manufacture of polycarbonates containing phthalimidine carbonate units of formula (4a), wherein R^{a}, R^{b}, p, and q are as in formula (4), R³ is each independently a C₁₋₆ alkyl group, j is 0 to 4, and R₄ is a C₁₋₆ alkyl, phenyl, or phenyl substituted with up to five C₁₋₆ alkyl groups. The phthalimidine carbonate units can be of formula (4b), wherein R⁵ is hydrogen or a C₁₋₆ alkyl. R⁵ can be hydrogen. Carbonate units (4a) wherein R⁵ is hydrogen can be derived from 2-phenyl-3,3′-bis(4-hydroxy phenyl)phthalimidine (also known as N-phenyl phenolphthalein bisphenol, or “PPPBP”) (also known as 3,3-bis(4-hydroxyphenyl)-2-phenylisoindolin-1-one).

Other bisphenol carbonate repeating units of this type are the isatin carbonate units of formula (4c) and (4d), wherein R^{a} and R^{b} are each independently C₁₋₁₂ alkyl, p and q are each independently 0 to 4, and R¹is C₁₋₁₂ alkyl, phenyl, optionally substituted with C₁₋₁₀ alkyl, or benzyl optionally substituted with C₁₋₁₀ alkyl. R^{a} and R^{b} can each be methyl, p and q can each independently be 0 or 1, and Rⁱ can be C₁₋₄ alkyl or phenyl.

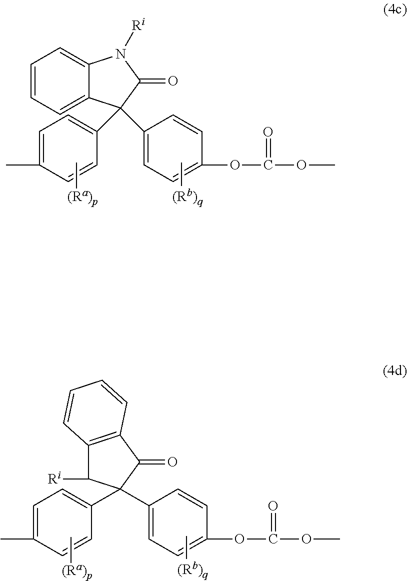

Examples of bisphenol carbonate units derived from bisphenols (4) wherein X^{b} is a substituted or unsubstituted C₃₋₁₈ cycloalkylidene include the cyclohexylidene-bridged, alkyl-substituted bisphenol of formula (4e), wherein R^{a} and R^{b} are independently each C₁₋₁₂ alkyl, R^{g} is C₁₋₁₂ alkyl, p and q are each independently 0 to 4, and t is 0 to 10. At least one of each of R^{a} and R^{b} can be disposed meta to the cyclohexylidene bridging group. R^{a} and R^{b} can each independently be C₁₋₄ alkyl, R^{g} can be C₁₋₄ alkyl, p and q can each be 0 or 1, and t is 0 to 5. R^{a}, R^{b}, and R^{g} can be each methyl, r and s can be each 0 or 1, and t can be 0 or 3, specifically, 0.

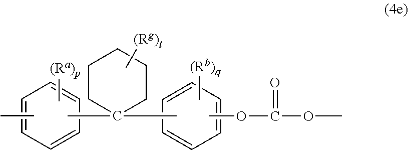

Examples of other bisphenol carbonate units derived from bisphenol (4) wherein X^{b} is a substituted or unsubstituted C₃₋₁₈ cycloalkylidene include adamantyl units (4f) and units (4g), wherein R^{a} and R^{b} are each independently C₁₋₁₂ alkyl, and p and q are each independently 1 to 4. At least one of each of R^{a} and R^{b} can be disposed meta to the cycloalkylidene bridging group. R^{a} and R^{b} can each independently be C₁₋₃ alkyl, and p and q can be each 0 or 1. R^{a}, R^{b} can be each methyl, p and q can each be 0 or 1. Carbonates containing units (4a) to (4g) are useful for making polycarbonates with high glass transition temperatures (Tg) and high heat distortion temperatures.

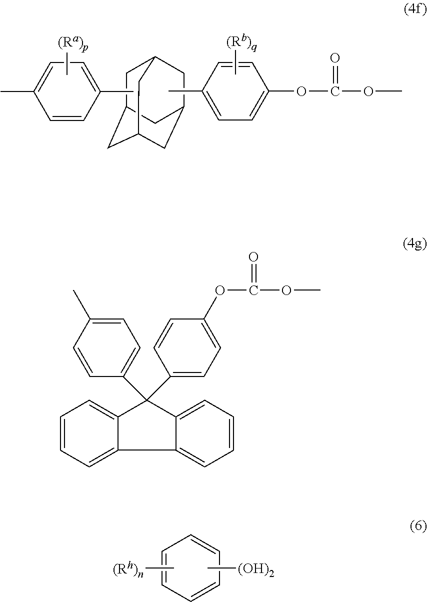

Other possible aromatic dihydroxy compounds of the formula HO—R¹—OH include compounds of formula (6), wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen can be bromine.

Some illustrative examples of specific aromatic dihydroxy compounds (herein also referred to as dihydroxy reactants) include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromo phenyl)propane, 1,1-bis (hydroxyphenyl)cyclopentane, 1,1-bis(4-hydroxyphenyl) cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha3-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′, 3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. The polycarbonate can be a linear homopolymer derived from bisphenol A, in which each of A¹ and A² can be p-phenylene, and Y¹ can be isopropylidene in formula (3).

“PC” includes homopolycarbonates (wherein each R¹ in the polymer is the same), copolymers comprising different R¹ moieties in the carbonate (“copolycarbonates”), copolymers comprising carbonate units and other types of polymer units, such as ester units, and combinations comprising at least one of homopolycarbonates and/or copolycarbonates.

The polycarbonate can be made by a melt polymerization process, which can be a continuous melt process. Generally, in a melt polymerization process, polycarbonates can be prepared by co-reacting, in a molten state, a dihydroxy reactant and a diaryl carbonate (herein also referred to as a diaryl carbonate ester), such as diphenyl carbonate. A useful melt process for making polycarbonates could also use a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicylic)carbonate, bis(4-methylcarboxylphenyl) carbonate, bis(2-acetylphenyl) carboxylate, bis(4-acetylphenyl) carboxylate, or a combination comprising at least one of the foregoing esters. The diaryl carbonate ester to dihydroxy reactant can be present in a molar ratio of 2:1 to 1:2, specifically, in a molar ratio of 1.5:1 to 1:1.5, more specifically, in a molar ratio of 1.05:1 to 1:1.05, even more specifically, in a molar ratio of 1:1.

In addition, transesterification catalyst(s) can be employed. Transesterification catalysts used in the melt transesterification polymerization production of polycarbonates can include one or both of an alkali catalyst and a quaternary catalyst, wherein the alkali catalyst comprises a source of at least one of alkali ions and alkaline earth ions, and wherein the quaternary catalyst comprising a quaternary ammonium compound, a quaternary phosphonium compound, or a combination comprising at least one of the foregoing. The quaternary catalyst can have a reduced metal salt concentration.

The alkali catalyst comprises a source of one or both of alkali ions and alkaline earth ions. The sources of these ions include alkaline earth hydroxides such as magnesium hydroxide and calcium hydroxide. Sources of alkali metal ions can include the alkali metal hydroxides such as illustrated by lithium hydroxide, sodium hydroxide, potassium hydroxide, and combinations comprising at least one of the foregoing. Examples of alkaline earth metal hydroxides are calcium hydroxide, magnesium hydroxide, and combinations comprising at least one of the foregoing. The alkali catalyst can comprise sodium hydroxide. The alkali catalyst typically will be used in an amount sufficient to provide 1×10⁻² to 1×10⁻⁸ moles, specifically, 1×10⁻⁴ to 1×10⁻⁷ moles of metal hydroxide per mole of the dihydroxy compounds employed. Other possible sources of alkaline earth and alkali metal ions include salts of carboxylic acids (such as sodium acetate) and derivatives of ethylene diamine tetraacetic acid (EDTA) (such as EDTA tetrasodium salt, and EDTA magnesium disodium salt), as well as combinations comprising at least one of the foregoing. For example, the alkali catalyst can comprise alkali metal salt(s) of a carboxylic acid, alkaline earth metal salt(s) of a carboxylic acid, or a combination comprising at least one of the foregoing. The alkali catalyst can comprise Na₂ Mg EDTA or a salt thereof.

The alkali can also, or alternatively, comprise salt(s) of a non-volatile inorganic acid. For example, the alkali catalyst can comprise salt(s) of a non-volatile inorganic acid such as NaH₂ PO₃, NaH₂PO₄, Na₂HPO₃, KH₂PO₄, CsH₂PO₄, Cs₂HPO₄, and combinations comprising at least one of the foregoing. Alternatively, or in addition, the alkali catalyst can comprise mixed alkali metal salt(s) of phosphoric acid, such as NaKHPO₄, CsNaHPO₄, CsKHPO₄, and combinations comprising at least one of the foregoing. The alkali catalyst can comprise KNaHPO₄, wherein a molar ratio of Na to K is 0.5 to 2.

The quaternary catalyst comprises a quaternary ammonium compound, a quaternary phosphonium compound, or a combination comprising at least one of the foregoing. The quaternary ammonium compound can be an organic ammonium compound(s) having structure, (R⁴)₄N⁺X⁻, wherein each R⁴ is the same or different, and is a C₁₋₂₀ alkyl, a C₄₋₂₀ cycloalkyl, or a C₄₋₂₀ aryl; and X⁻is an organic or inorganic anion, for example, a hydroxide, halide, carboxylate, sulfonate, sulfate, formate, carbonate, or bicarbonate. Some non-limiting examples of organic quaternary ammonium compounds include tetramethyl ammonium hydroxide, tetrabutyl ammonium hydroxide, tetramethyl ammonium acetate, tetramethyl ammonium formate, tetrabutyl ammonium acetate, and combinations comprising at least one of the foregoing. Tetramethyl ammonium hydroxide is often employed.

The quaternary phosphonium compound can be of organic phosphonium compounds having structure, (R⁵)₄P⁺X⁻, wherein each R⁵ is the same or different, and is a C₁₋₂₀ alkyl, a C₄₋₂₀ cycloalkyl, or a C₄₋₂₀ aryl; and X⁻ is an organic or inorganic anion, for example, a hydroxide, phenoxide, halide, carboxylate such as acetate or formate, sulfonate, sulfate, formate, carbonate, or bicarbonate. Where X⁻ is a polyvalent anion such as carbonate or sulfate, it is understood that the positive and negative charges in the quaternary ammonium and phosphonium structures are properly balanced. Where each R⁵ independently is a methyl group and X⁻ is carbonate, it is understood that X⁻ represents 2(CO₃⁻²).

Examples of quaternary phosphonium compounds include tetramethyl phosphonium hydroxide, tetramethyl phosphonium acetate, tetramethyl phosphonium formate, tetrabutyl phosphonium hydroxide, tetraphenyl phosphonium acetate (TPPA), tetraphenyl phosphonium phenoxide (TPPP), tetraethyl phosphonium acetate, tetrapropyl phosphonium acetate, tetrabutyl phosphonium acetate, tetrapentyl phosphonium acetate, tetrahexyl phosphonium acetate, tetraheptyl phosphonium acetate, tetraoctyl phosphonium acetate, tetradecyl phosphonium acetate, tetradodecyl phosphonium acetate, tetratolyl phosphonium acetate, tetramethyl phosphonium benzoate, tetraethyl phosphonium benzoate, tetrapropyl phosphonium benzoate, tetraphenyl phosphonium benzoate, tetraethyl phosphonium formate, tetrapropyl phosphonium formate, tetraphenyl phosphonium formate, tetramethyl phosphonium propionate, tetraethyl phosphonium propionate, tetrapropyl phosphonium propionate, tetramethyl phosphonium butyrate, tetraethyl phosphonium butyrate, and tetrapropyl phosphonium butyrate, and combinations comprising at least one of the foregoing. The quaternary catalyst can comprise TPPP, TPPA, or a combination comprising one or both of the foregoing.

The amount of second quaternary employed is typically based upon the total number of moles of dihydroxy compound employed in the polymerization reaction. When referring to the ratio of quaternary catalyst, for example, phosphonium salt, to all dihydroxy compounds employed in the polymerization reaction, it is convenient to refer to moles of phosphonium salt per mole of the dihydroxy compound(s), meaning the number of moles of phosphonium salt divided by the sum of the moles of each individual dihydroxy compound present in the reaction mixture. The amount of quaternary catalyst employed typically will be 1×10⁻² to 1×10⁻⁵, specifically, 1×10⁻³ to 1×10⁻⁴ moles per total mole of the dihydroxy compounds in the reaction mixture.

The quaternary catalyst can have a reduced concentration of metal compounds, e.g., the quaternary catalyst can comprise one or more of: a) less than or equal to 2,000 ppm, specifically, less than or equal to 1,675 ppm, specifically, less than or equal to 500 ppm, more specifically, less than or equal to 100 ppm, even more specifically, less than or equal to 30 ppm of sodium; b) less than or equal to 500 ppm, specifically, less than or equal to 300 ppm, more specifically, less than or equal to 135 ppm of cesium; and c) less than or equal to 100 ppm, specifically, less than or equal to 45 ppm of potassium; based on the total weight of the quaternary catalyst.

The quaternary catalyst can comprise an alkali metal compound, wherein if the compound comprises sodium sulfate, the amount of sodium can be less than or equal to 1,690 ppm, specifically, less than or equal to 1,670 ppm based on the total weight of the quaternary catalyst; if the compound comprises cesium sulfate, the amount of cesium can be less than or equal to 275 ppm, specifically, less than or equal to 252 ppm based on the total weight of the quaternary catalyst; if the compound comprises sodium hydroxide, the amount of sodium can be less than or equal to 35 ppm, specifically, less than or equal to 29 ppm based on the total weight of the quaternary catalyst; if the compound comprises potassium hydroxide, the amount of potassium can be less than or equal to 50 ppm, specifically, less than or equal to 43 ppm based on the total weight of the quaternary catalyst; if the compound comprises cesium hydroxide, the amount of cesium can be less than or equal to 140 ppm, specifically, less than or equal to 132 ppm based on the total weight of the quaternary catalyst; or a combination comprising one or more of the foregoing.

For example, the quaternary catalyst can comprise an alkali metal compound, wherein the amount of sodium can be greater than or equal to 1 ppm, or greater than or equal to 30 ppm, or greater than or equal to 100 ppm; the amount of cesium can be greater than or equal to 10 ppm, or greater than or equal to 30 ppm, or greater than or equal to 50 ppm; the amount of potassium can be greater than 0 ppm, or greater than or equal to 5 ppm, or greater than or equal to 10 ppm; or a combination comprising one or more of the foregoing, wherein the metal amounts are based on the weight of the quaternary catalyst.

A quencher composition can be added at one or more locations in the present melt preparation of the polycarbonate to reduce the activity of the catalyst. The quencher composition comprises a quenching agent (also referred to herein as a quencher). For example, the quenching agent can comprise a sulfonic acid ester such as an alkyl sulfonic ester of the formula R₁SO₃R₂ wherein R₁ is hydrogen, C₁-C₁₂ alkyl, C₆-C₁₈ aryl, or C₇-C₁₉ alkylaryl, and R₂ is C₁-C₁₂ alkyl, C₆-C₁₈ aryl, or C₇-C₁₉ alkylaryl. Examples of alkyl sulfonic esters include benzenesulfonate, p-toluenesulfonate, methylbenzene sulfonate, ethylbenzene sulfonate, n-butyl benzenesulfonate, octyl benzenesulfonate and phenyl benzenesulfonate, methyl p-toluenesulfonate, ethyl p-toluenesulfonate, n-butyl p-toluene sulfonate, octyl p-toluenesulfonate and phenyl p-toluenesulfonate. The sulfonic acid ester can comprise alkyl tosylates such as n-butyl tosylate. The sulfonic acid ester can be present in the quencher composition in an amount of 0.1 to 10 volume percent (vol %), specifically, 0.1 to 5 vol%, more specifically, 0.5 to 2 vol % based on the total volume of the quencher composition.

The quencher composition can be added to the polycarbonate at a pressure of greater than or equal to 2 bars and mixed with the polycarbonate for a period of time of greater than or equal to 5 seconds prior to the addition to the polycarbonate of any additives having a reactive OH group or reactive ester group. As used herein, when referring to “reactive” or a “reactive group”, e.g., having a reactive OH group or a reactive ester group, the reactivity is with respect to polycarbonate.

Polycarbonates polymerized from such a purified diaryl carbonate can have a low color value of, for example, a CIE b* index of less than or equal to 0.5, specifically, less than or equal to 0.15 as determined by spectrophotometry and high light transmission of, for example, greater than or equal to 89% as determined by spectrophotometry.

The polycarbonate can have a number average molecular weight (Mn) of 8 and 25 kilodaltons (kDa) (using polycarbonate standard), specifically, 13 to 18 kDa.

A polycarbonate polymerized from the purified diaryl carbonate can comprise less than or equal to 33 ppb, specifically, less than or equal to 20 ppb of molybdenum; less than or equal to 33 ppb, specifically, less than or equal to 20 ppb vanadium; less than or equal to 33 ppb, specifically, less than or equal to 20 ppb chromium; less than or equal to 75 ppb, specifically, less than or equal to 50 ppb titanium; less than or equal to 375 ppb, specifically, less than or equal to 250 ppb of niobium; less than or equal to 33 ppb, specifically, less than or equal to 20 ppb of nickel; less than or equal to 10 ppb, specifically, less than or equal to 5 ppb zirconium; less than or equal to 10 ppb, specifically, less than or equal to 5 ppb of iron, or a combination comprising one or more of the foregoing.

The PC can be further compounded, for example, to make a PC blend.

The following examples are provided to illustrate the present process. The examples are merely illustrative and are not intended to limit devices made in accordance with the disclosure to the materials, conditions, or process parameters set forth therein.

### EXAMPLES

### Examples 1-6

The solubility of diphenyl carbonate in various ketones was determined. Solubility was determined based on a gravimetric method. The solubility is shown in Table 1, where NA stands for non-applicable as the melting point of benzophenone is 48.5° C.

TABLE 1

| Example | 1 | 2 | 3 | 4 | 5 | 6 |
|---|---|---|---|---|---|---|
| Temperature (° C.) | 70 | 50 | 50 | 25 | 25 | 25 |
| molar ratio of | 1:1 | 1:1 | 1.5:1 | 1:1 | 1.5:1 | 2:1 |
| ketone to DPC | | | | | | |
| MIBK | Yes | No | Yes | No | No | No |
| Benzophenone | Yes | No | Yes | NA | NA | NA |
| Cyclohexanone | Yes | Yes | Yes | No | No | Yes |
| Acetophenone | Yes | Yes | Yes | No | No | Yes |
| Butanone | Yes | No | Yes | No | No | Yes |
| Diethyl ketone | Yes | No | Yes | No | No | Yes |

Table 1 shows that increasing one or both of the temperature and the molar ratio of the ketone results in an increased solubility of the diphenyl carbonate in the solution.

Set forth below are some embodiments of the present method of polymerizing a polycarbonate.

Embodiment 1: An integrated method for producing a polycarbonate, comprising making a liquid mixture comprising a ketone and a monomer, wherein the monomer comprises a diaryl carbonate or a dihydroxy compound; transporting the liquid mixture to a polycarbonate production plant; reacting the monomer and a second monomer in a polymerization unit to produce the polycarbonate and a phenol byproduct, wherein the second monomer comprises the other of the diaryl carbonate and the dihydroxy compound; wherein the ketone comprises a non-acetone ketone.

Embodiment 2: The method of Embodiment 1, wherein the reacting further comprises recovering the ketone as a recovered ketone; and /or prior to reacting, separating the monomer from the ketone in the production plant as a separated ketone.

Embodiment 3: The method of any of the preceding embodiments, further comprising, prior to reacting, separating the monomer from the ketone in the production plant as a separated ketone.

Embodiment 4: The process of Embodiments 2 or 3, further comprising adding at least one of the separated ketone and the recovered ketone to a reaction vessel and reacting it with a monohydroxy compound to produce a second dihydroxy compound, wherein the reaction vessel has an alcohol content of less than or equal to 100 ppm; and adding the second dihydroxy compound to the melt polymerization unit.

Embodiment 5: The method of any Embodiments 2-4, further comprising reducing an alcohol content in at least one of the separated ketones and the recovered ketone by reacting an alcohol with a second diaryl carbonate in the presence of a catalyst to form a reaction mixture comprising an aryl alkyl carbonate and a hydroxy compound; and separating the aryl alkyl carbonate from the reaction mixture.

Embodiment 6: The method of any of the preceding embodiments, wherein a molar ratio of the ketone to the monomer of the liquid mixture is 0.5:1 to 7:1.

Embodiment 7: The method of any of the preceding embodiments, further comprising reducing an alcohol content of the monomer prior to reacting in the polymerization unit.

Embodiment 8: The method of Embodiment 7, wherein the reducing comprises reacting an alcohol with a second diaryl carbonate in the presence of a catalyst to form a reaction mixture comprising an aryl alkyl carbonate and a hydroxy compound; and separating the aryl alkyl carbonate from the reaction mixture.

Embodiment 9: The method of any of Embodiments 7-8, wherein the diaryl carbonate and the second diaryl carbonate are the same material.

Embodiment 10: The method of any of the preceding embodiments, wherein the ketone comprises methyl isobutyl ketone, benzophenone, cyclohexanone, acetophenone, butanone, diethyl ketone, or a combination comprising one or more of the foregoing.

Embodiment 11: The method of any of the preceding embodiments, wherein the liquid mixture has a temperature during the transporting of 20 to 70° C.

Embodiment 12: The method of any of the preceding embodiments, wherein the monomer comprises a diaryl carbonate of the formula (I).

Embodiment 13: The method of any of the preceding embodiments, wherein the monomer comprises diphenyl carbonate.

Embodiment 14: The method of any of the preceding embodiments, wherein the dihydroxy compound comprises bisphenol benzophenone, bisphenol cyclohexanone, bisphenol acetophenone; bisphenol butanone, or a combination comprising one or more of the foregoing.

Embodiment 15: The method of any of the preceding embodiments, further comprising adding a quencher composition to the polycarbonate at a pressure of greater than or equal to 2 bars; and mixing the quencher composition with the polycarbonate for a period of time of greater than or equal to 5 seconds prior to the addition to the polycarbonate of any additives having a reactive OH group or reactive ester group.

Embodiment 16: The method of any of the preceding embodiments, wherein the ketone has a metal level according to the formula (F), wherein Mk is the amount of metal in the ketone in ppb; Mw(ketone) is the weight average molecular weight of the ketone; Mw(monomer) is the weight average molecular weight of the monomer that is mixed with the ketone; and

MB is the amount of metal for each different metal and comprises the following: molybdenum: less than or equal to 38 ppb, specifically, less than or equal to 23 ppb; and/or vanadium: less than or equal to 38 ppb, specifically, less than or equal to 23 ppb; and/or chromium: less than or equal to 38 ppb, specifically, less than or equal to 23 ppb; and/or titanium: less than or equal to 85 ppb, specifically, less than or equal to 57 ppb; and/or niobium: less than or equal to 425 ppb, specifically, less than or equal to 284 ppb; and/or nickel: less than or equal to 38 ppb, specifically, less than or equal to 23 ppb; and/or zirconium: less than or equal to 12 ppb, specifically, less than or equal to 6 ppb; and/or iron: less than or equal to 12 ppb, specifically, less than or equal to 6 ppb.

Embodiment 17: The method of any of the preceding embodiments, wherein the ketone is present in the reaction mixture in an amount of 10 to 90 wt %, based upon a total weight of the reaction mixture, and wherein the reaction mixture optionally comprises less than or equal to 10 wt % acetone.

Embodiment 18: The method of any of the preceding embodiments, wherein reaction mixture comprises no acetone.

Embodiment 19: The method of any of the preceding embodiments, wherein, wherein the diaryl carbonate comprises less than or equal to 38 ppb of molybdenum; less than or equal to 38 ppb vanadium; less than or equal to 38 ppb chromium; less than or equal to 85 ppb titanium; less than or equal to 425 ppb of niobium; less than or equal to 38 ppb of nickel; less than or equal to 12 ppb zirconium; less than or equal to 12 ppb of iron, or a combination comprising one or more of the foregoing all based on the total weight of the diaryl carbonate.

Embodiment 20: The method of any of the preceding embodiments, wherein the polycarbonate is produced in a polymerization section, and further comprising processing the polycarbonate in an extruder that is in line with the polymerization section.

Embodiment 21: The method of any of the preceding embodiments, wherein a temperature during the transporting is 20 to 30° C., wherein the ketone comprises cyclohexanone, acetophenone, butanone, diethyl ketone, or a combination comprising one or more of the foregoing, and wherein a molar ratio of the ketone and the monomer is 1.6:1 to 3:1 or 1.6:1 to 7:1.

Embodiment 22: The method of any of Embodiments 1-20, wherein a temperature during the transporting is 40 to 60° C., wherein the ketone comprises MIBK, benzophenone, cyclohexanone, acetophenone, butanone, diethyl ketone, or a combination comprising one or more of the foregoing, and wherein a molar ratio of the ketone and the monomer is 1.3:1 to 3:1 or 1.3:1 to 7:1 or 1.3:1 to 2:1

Embodiment 23: The method of any of Embodiments 1-20, wherein a temperature during the transporting is 40 to 60° C., wherein the ketone comprises cyclohexanone, acetophenone, or a combination comprising one or both of the foregoing, and wherein a molar ratio of the ketone and the monomer is 0.5:1 to 3:1 or 0.5:1 to 7:1 or 0.5:1 to 2:1.

Embodiment 24: The method of any of Embodiments 1-20 wherein a temperature during the transporting is 60 to 80° C., wherein the ketone comprises MIBK, benzophenone, cyclohexanone, acetophenone, butanone, diethyl ketone, or a combination comprising one or more of the foregoing, and wherein a molar ratio of the ketone and the monomer is 0.5:1 to 3:1 or 0.5:1 to 7:1 or 0.5:1 to 2:1.

Embodiment 25: The method of any of the preceding embodiment, wherein the reacting the monomer and the second monomer occurs in the presence of one or both of an alkali catalyst comprising a source of one or both of alkali ions and alkaline earth ions; and a second catalyst comprising a quaternary ammonium compound, a quaternary phosphonium compound, or a combination comprising at least one of the foregoing.

Embodiment 26: The method of Embodiment 25, wherein the alkali catalyst comprises KNaHPO₄, wherein a molar ratio of Na to K is 0.5 to 2.

Embodiment 27: The method of any of Embodiments 25-26, wherein the quaternary catalyst comprises TPPP, TPPA, or a combination comprising one or both of the foregoing.

Embodiment 28: The method of any of Embodiments 25-27, wherein the quaternary catalyst comprises a metal compound, wherein the metal comprises at least one of sodium, potassium, and cesium; wherein if the compound comprises sodium sulfate, the amount of sodium is 0 to 1,690 ppm; if the compound comprises cesium sulfate, the amount of cesium is 0 to 275 ppm; if the compound comprises sodium hydroxide, the amount of sodium is 0 to 35 ppm; if the compound comprises potassium hydroxide, the amount of potassium is 0 to 50 ppm; if the compound comprises cesium hydroxide, the amount of cesium is 0 to 140 ppm; all based on the weight of the quaternary catalyst.

Embodiment 29: A polycarbonate formed by the method of any of Embodiments 1-28.

Embodiment 30: The polycarbonate of Embodiment 29, wherein the polycarbonate has a metal level of less than or equal to 38 ppb of molybdenum; less than or equal to 38 ppb of vanadium; less than or equal to 38 ppb of chromium; less than or equal to 85 ppb of titanium; less than or equal to 425 ppb of niobium; less than or equal to 38 ppb of nickel; less than or equal to 12 ppb of zirconium; less than or equal to 12 ppb of iron, or a combination comprising one or more of the foregoing.

Embodiment 31: A use of a liquid mixture in the production of polycarbonate, wherein the liquid mixture comprising a ketone and at least one of diaryl carbonate and dihydroxy compound, and wherein the liquid mixture comprises less than or equal to 100 ppm alcohol based on the total weight of the ketone, wherein the ketone comprises a non-acetone ketone.

Embodiment 32: The liquid mixture of Embodiment 31, wherein ketone in the liquid mixture has been reacted with a diaryl carbonate in the presence of a catalyst to form an aryl alkyl carbonate, and wherein the aryl alkyl carbonate has been removed before production the polycarbonate.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt %, or, more specifically, 5 to 20 wt %”, is inclusive of the endpoints and all intermediate values of the ranges of “5 to 25 wt %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment,” “another embodiment,” “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to Applicants or others skilled in the art. Accordingly, the appended claims as filed and as they may be amended are intended to embrace all such alternatives, modifications variations, improvements, and substantial equivalents.

This application claims the benefit of European Patent Application Serial No. 14382438 filed 5 Nov. 2014. The related application is incorporated herein by reference.

I/We claim:

1. An integrated method for producing a polycarbonate, comprising:
making a liquid mixture comprising a ketone and a monomer, wherein the monomer comprises a diaryl carbonate or a dihydroxy compound;
transporting the liquid mixture to a polycarbonate production plant;
reacting the monomer and a second monomer in a polymerization unit to produce the polycarbonate and a phenol byproduct, wherein the second monomer comprises the other of the diaryl carbonate and the dihydroxy compound;
wherein the ketone comprises a non-acetone ketone.

2. The method of claim 1, wherein the reacting further comprises
recovering the ketone from the polymerization unit as a recovered ketone; and/or
prior to reacting, separating the monomer from the ketone in the production plant as a separated ketone.

3. The process of claim 2, further comprising
adding at least one of the separated ketone and the recovered ketone to a reaction vessel to form a ketone mixture and reacting the ketone mixture with an aromatic monohydroxy compound to produce a second dihydroxy compound, wherein the ketone mixture has an alcohol content of less than or equal to 100 ppm; and
adding the second dihydroxy compound to the melt polymerization unit.

4. The process of claim 3, wherein the aromatic monohydroxy compound has a water content of less than or equal to 1 wt %, based upon a total weight of the aromatic monohydroxy compound.

5. The method of any claim 2, further comprising reducing an alcohol content in at least one of the separated ketone and the recovered ketone by reacting an alcohol with a second diaryl carbonate in the presence of a catalyst to form a reaction mixture comprising an aryl alkyl carbonate and a hydroxy compound; and separating the aryl alkyl carbonate from the reaction mixture.

6. The method of claim 1, further comprising reducing an alcohol content of the monomer prior to reacting in the polymerization unit, wherein the reducing comprises reacting an alcohol with a second diaryl carbonate in the presence of a catalyst to form a reaction mixture comprising an aryl alkyl carbonate and a hydroxy compound; and separating the aryl alkyl carbonate from the reaction mixture.

7. The method of claim 5, wherein the diaryl carbonate and the second diaryl carbonate are the same material.

8. The method of claim 1, wherein a molar ratio of the ketone to the monomer of the liquid mixture is 0.5:1 to 7:1.

9. The method claim 1, wherein the ketone comprises methyl isobutyl ketone, benzophenone, cyclohexanone, acetophenone, butanone, diethyl ketone, or a combination comprising one or more of the foregoing.

10. The method of claim 1, wherein the liquid mixture has a temperature during the transporting of 20 to 70° C.

11. The method of claim 1, wherein the monomer comprises diphenyl carbonate.

12. The method of any claim 1, wherein the dihydroxy compound comprises bisphenol benzophenone, bisphenol cyclohexanone, bisphenol acetophenone, bisphenol butanone, or a combination comprising one or more of the foregoing.

13. The method of claim 1, further comprising adding a quencher composition to the polycarbonate at a pressure of greater than or equal to 2 bars; and mixing the quencher composition with the polycarbonate for a period of time of greater than or equal to 5 seconds prior to the addition to the polycarbonate of any additives having a OH group or reactive ester group.

14. The method of any of claim 1, wherein the ketone has a metal level according to the following formula:
Mₖ≦M_{B}(M_{w(ketone)}/M_{w(monomer)})
wherein:
Mk is the amount of metal in the ketone in ppb;
Mw(ketone) is the weight average molecular weight of the ketone;
Mw(monomer) is the weight average molecular weight of the monomer that is mixed with the ketone; and
M_{B} is the amount of metal for each different metal and comprises the following:
molybdenum: less than or equal to 38 ppb; and/or
vanadium: less than or equal to 38 ppb; and/or
chromium: less than or equal to 38 ppb; and/or
titanium: less than or equal to 85 ppb; and/or
niobium: less than or equal to 425 ppb; and/or
nickel: less than or equal to 38 ppb; and/or
zirconium: less than or equal to 12 ppb; and/or
iron: less than or equal to 12 ppb.

15. The method claim 1, wherein the ketone is present in the reaction mixture in an amount of 10 to 90 wt %, based upon a total weight of the reaction mixture.

16. The method of claim 1, wherein the diaryl carbonate comprises less than or equal to 38 ppb of molybdenum; less than or equal to 38 ppb vanadium; less than or equal to 38 ppb chromium; less than or equal to 85 ppb titanium; less than or equal to 425 ppb of niobium; less than or equal to 38 ppb of nickel; less than or equal to 12 ppb zirconium; less than or equal to 12 ppb of iron, or a combination comprising one or more of the foregoing all based on the total weight of the diaryl carbonate.

17. The method of any of claim 1,
wherein the polycarbonate is produced in a polymerization section, and further comprising processing the polycarbonate in an extruder that is in line with the polymerization section.

18. A polycarbonate formed by the method of preceding claim 1.

19. A use of a liquid mixture in the production of polycarbonate, wherein the liquid mixture comprises a ketone and at least one of diaryl carbonate and dihydroxy compound, and wherein the liquid mixture comprises less than or equal to 100 ppm alcohol based on the total weight of the ketone, wherein the ketone comprises a non-acetone ketone.

20. The liquid mixture of claim 19, wherein ketone in the liquid mixture has been reacted with a diaryl carbonate in the presence of a catalyst to form an aryl alkyl carbonate, and wherein the aryl alkyl carbonate has been removed before production the polycarbonate.
